(19) United States
(12) Patent Application Publication
(10) Pub. No.: US 2007/0124583 A1
(43) Pub. Date: May 31, 2007

(54) METHOD FOR STORING AND TRANSFER OF RIGHTS OBJECTS BETWEEN DEVICES AND DEVICE EXPLOITING THE METHOD

(75) Inventors: Stefan Andersson, Klagerup (SE); Fredrik Lofgren, Malmo (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SONY ERICSSON MOBILE COMMUNICATIONS AB, Lund (SE)

(21) Appl. No.: 11/164,494

(22) Filed: Nov. 25, 2005

(51) Int. Cl. H04L 9/00

(52) U.S. Cl. 713/165

(57) ABSTRACT

The invention relates to a method for storing and transfer of a rights object, and particularly a rights object containing a key for decryption of a content item, both supplied by a content provider/rights issuer and stored in a device. The rights object is stored in a separate file protected by means of a key file decryption key. This key file decryption key is stored in another separate file, which in turn is encrypted with a secondary key, which enables secure transfer of the rights object to another device

### FIELD OF THE INVENTION

The present invention relates to a method for storing and transfer of a rights object, and particularly a rights object containing a key for decryption of a content item, both supplied by a content provider/rights issuer and stored in a device. The rights object is stored in a separate file protected by means of a key file decryption key. This key file decryption key is stored in another separate file, which in turn is encrypted with a secondary key, which enables secure transfer of the rights object to another device. The present invention also relates to a device exploiting the method.

### RELATED ART

In modern devices a Digital Rights Management, DRM, scheme is used to control usage of content items, like wallpapers, ring tones, games etc in mobile telephones. For advanced forms of DRM, the content is encrypted. To decrypt the content one uses a corresponding license file called Rights Object, RO, containing a decryption key. With reference to FIG. 1, the encrypted content item 1 is downloaded over a communications channel 9 to a device, such as a mobile station. The communications channel may be wireless Internet (WAP Wireless Application Protocol), short-range radio, infrared light or an external memory medium. The rights object file 2 is downloaded separately over another communications channel 10, preferably HTTP secure protocol or automatically generated transmissions (push). When both files are downloaded, the content item may be used.

With the current DRM scheme, the end consumer buys content that is stored on the device, on an internal or external storage. To use the content the corresponding rights object is used. One can say that the value of the bought content is tied to the rights object. When the user buys a new device, he does not want to repeat the purchase with the new device downloading the content item and rights object again. Instead, he will want to use the content items in the new device. This requires that the rights objects are transferred to the new device. Because the rights object represent a great value to the content provider and are used to control payments relating to the content item, the transfer needs to be done in secure and controlled way.

### SUMMARY OF THE INVENTION

One object of the invention is to enable a robust transfer of a rights object. The rights object is stored in the device in a file encrypted with a key file decryption key. This key file decryption key is stored in a separate file, which in turn is encrypted with a secondary key. The secondary key is either a key specific to the device to receive the transferred rights object or a key issued by the original content provider/rights issuer. Thus, the receiving device will be capable of regenerating the rights object file by means of its own specific key or interaction with the rights issuer.

In a first aspect, the invention provides a method for transfer of a content item and associated rights object from a first device to a second device, the content item being encrypted with the rights object, both the content item and the rights object initially being stored in the first device, comprising the steps of: in the first device,
forming an encrypted rights object file containing at least one rights object and being encrypted with a key file decryption key;
forming an encrypted key file containing said key file decryption key encrypted with a secondary key;
transferring from the first device to the second device: the content item, the encrypted rights object file, and the encrypted key file;
and in the second device:
receiving the content item, the encrypted rights object file, and the encrypted key file;
regenerating the key file decryption key from the encrypted key file by decryption with the secondary key;
decrypting the rights object file with the key file decryption key; and decrypting the content item file with the associated rights object.

The encrypted key file may be deleted from the first device after transfer thereof.

The encrypted rights object file may be deleted from the first device after transfer thereof.

A connection between the first device and the second device may be established.

In one embodiment, the secondary key is a device specific key of the second device, exchanged over the connection and used by the first device to encrypt the key file.

The connection may be established over a storage medium, the storage medium temporarily storing the files to be transferred.

The encrypted key file may be deleted from the storage medium after the second device has received the encrypted key file.

The connection may be established over an infrared link or over a radio link.

In another embodiment, the secondary key is a public key of the rights issuer who issued the rights object, the method comprising the further steps, in the first device, of downloading said public key of the rights issuer, inserting the URL address of the rights issuer in the key file and using said public key to encrypt the key file, and in the second device, after receiving the encrypted rights object file and encrypted key file, establishing a connection to the rights issuer, sending the key file together with its own public key to the rights issuer, the rights issuer decrypting the key file with its own private key, and encrypting the key file with the public key of the second device, the rights issuer sending this newly encrypted key file to the second device who in turn decrypts the key file with its own private key.

The rights object may be defined to allow transfer using a public key of the rights issuer who issued the rights object exclusively.

The file transfer may be performed by means of an external memory.

In a second aspect, the invention provides a device comprising: a storage means for storing files, processor means capable of performing encryption and decryption operations, and of executing a content item, wherein the device is adapted to transfer a content item and associated rights object to another device by:
forming an encrypted rights object file containing at least one rights object and being encrypted with a key file decryption key;
forming an encrypted key file containing said key file decryption key encrypted with a secondary key;
transferring the content item, the encrypted rights object file, and the encrypted key file to said other device; and wherein the device is adapted to receive a content item and associated rights object from another device by:
receiving the content item, the encrypted rights object file, and the encrypted key file;
regenerating the key file decryption key from the encrypted key file by decryption with the secondary key;
decrypting the rights object file with the key file decryption key; and
decrypting the content item file with the associated rights object.

The device may be adapted to delete the encrypted key file after transfer thereof.

The device may be adapted to delete the encrypted rights object file after transfer thereof.

The device may be adapted to establish a connection to the other device.

In one embodiment, the device is adapted to receive a device specific key of the other device over the connection and to use it as the secondary key to encrypt the key file.

The device may be adapted to establish the connection over a storage medium, and to store the files to be transferred temporarily on the storage medium.

The device (during reception) may be adapted to delete the encrypted key file from the storage medium after the device has regenerated the key file decryption key.

The device may be adapted to establish the connection over an infrared link or over a radio link.

For transfer, the device may be adapted to download a public key of the rights issuer who issued the rights object, insert the URL address of the rights issuer in the key file and use said public key to encrypt the key file, and for reception, after receiving the encrypted rights object file and encrypted key file, the device may be adapted to establish a connection to the rights issuer, to send the key file together with its own public key to the rights issuer RI, to receive the key file decrypted with the private key of the rights issuer, and re-encrypted with the public key of the device, and to decrypt the key file with its own private key.

The device may further comprise a connector for connecting an external memory, and may be adapted to perform the file transfer by means of such an external memory.

The device may be a portable telephone, a pager, a communicator, a smart phone, an electronic organiser, a computer, a personal digital assistant, or an mp3 player.

### BRIEF DESCRIPTION OF THE DRAWINGS

The invention will be described in detail below with reference to the attached drawings, of which:

FIG. 1 is a schematic diagram of a download of a content item and a rights object;

FIG. 2 is a schematic diagram of a mobile station storing files in accordance with the invention;

FIG. 3 is a schematic diagram of a transfer between two mobile stations;

FIG. 4 is a flow diagram of a transfer procedure according to the invention; and

FIG. 5 is a schematic diagram of a transfer of keys and encrypted key files between a mobile station and a rights issuer.

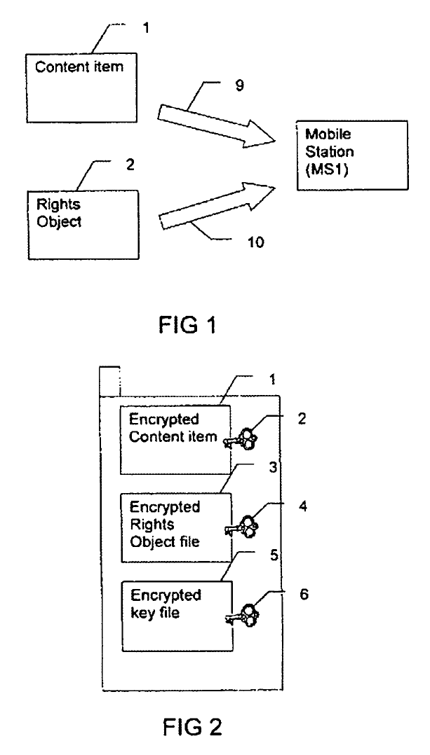

### DETAILED DESCRIPTION OF THE PREFERRED EMBODIMENTS

The invention will be described with a mobile telephone as an example. The invention is equally applicable to other devices, such as pagers, communicators, smart phones, electronic organisers, computers, personal digital assistants (PDAs), as well as mp3 players. This disclosure will concentrate on the technical aspects relevant to the invention, while other functions necessary for the operation of the device may be conventional.

The invention will be described in the context of downloading content items to mobile telephones, in this specification referred to as mobile stations. Generally, content items are protected by a digital rights management, DRM, scheme. As is known, DRM is a system for protecting e.g. the copyrights of digital content that is distributed online. A DRM system provides a container format that may include album and track titles and a set of rules for enforcing copyright compliance that software and hardware players must support in order to play back material. A content provider may use DRM for controlling that a person downloading a content item also has paid or will pay before the content item can be used. The content provider may for example incorporate a payment directive in the content item, suitably in the rights object, RO, container used in DRM.

A user who has bought a content item will want to be able to transfer it when he buys a new device. The content provider cannot allow copying of rights objects in an uncontrolled fashion. The problem would be solved if the rights object could be transferred in a safe way.

FIG. 2 shows an embodiment of the invention with an arrangement of various files containing content items and keys. The files may be stored in internal or external memories. The files include one encrypted content item 1. The content item is encrypted by means of a rights object 2. A separate file 3 contains the rights object, possibly all rights objects used in the device. This file is in turn encrypted by means of a key 4, in this specification referred to as a key file decryption key, KFK, produced by the device. The key file decryption key KFK 4 is stored in another file, the encrypted key file 5 which is in turn encrypted with a secondary key 6.

Since the device belongs to the user who made the original purchase of the content item, the key file decryption key produced by the device guarantees the security of the encrypted rights object file. Since the rights object file is encrypted, it can be transferred in a secure way.

The key file 5 is always encrypted with a key which is unique to the device. To guarantee safe transfer, a copy of the key file 5 to be used for the transfer is encrypted with at least one additional secondary key. One possibility is to use a secondary key which is unique to the device which is to receive the content item and the rights object. First, the device unique key, DUK, of the second device, e.g. its public key, is transferred to the first device, which uses the secondary key to encrypt the key file. Then, the encrypted key file 5 may be transferred to the second device.

Another possibility is that the key file 5 is encrypted with a secondary key issued by the original content provider/rights issuer. In this case, the secondary key does not have to be transferred between exchanging devices, but the second device, which is to receive the content item and rights object, may instead exchange keys with the content provider/rights issuer. Even though a key has to be downloaded once in each device, at least the content item itself and the associated rights object may be transferred between the devices.

The transfer procedure guarantees that the content item cannot be used in two devices at the same time (even if the content item and the rights object may exist in both devices at the same time protected with their respective keys). In this way, the content provider is safeguarded against unauthorized copying and use of the content item.

The encrypted rights object file 3 can either be created on an explicit backup request as a preparation for a transfer, or it can be continuously updated in order to carry the current state of the rights objects. If the encrypted rights object file is updated continuously, the encrypted key file 5 is encrypted with a device unique key when the file is first created.

In any case, the encrypted rights object file should be protected on the device. Typically, it is both integrity protected, using a message authentication code, MAC, and encrypted. The key material for both operations can be the derived from the KFK.

Generally, the transfer may be indirect or direct. In indirect transfer, there is no connection between the mobile stations, but the files are temporarily stored on a storage medium which is transferred from the first mobile station to the second mobile station. The indirect case requires that the secondary key 6, used for encryption of the key file 5, for example, be a public key of the rights issuer. In the direct transfer, there is a connection between the first mobile station and the second mobile station. In this case, the secondary key 6 for encryption of the key file 5 may be a device unique key of the second mobile station, which is used by the first mobile station. However, also the direct transfer may use a public key of the rights issuer.

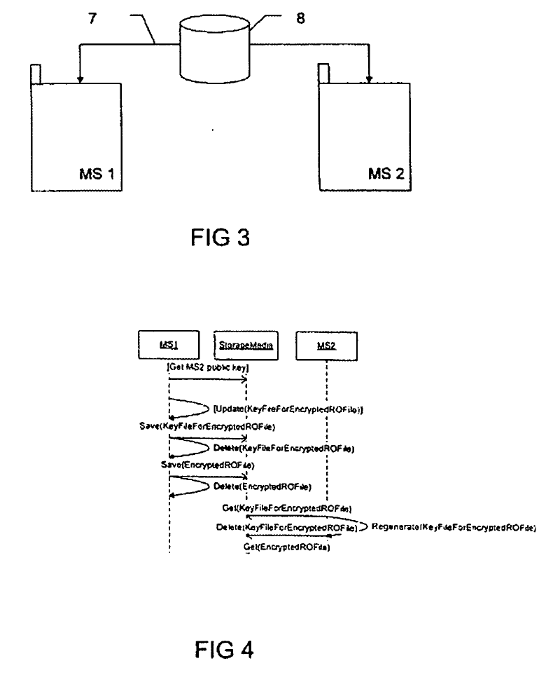

A device set-up useful in the present invention is schematically illustrated in FIG. 3. A first mobile station MS1 is connected by means of a connection 7 to a second mobile station MS2. In this example, MS1 is the device from which the files are sent. The second mobile station MS2 is the device to which the content item and other files are to be transferred.

The connection 7 may be a virtual storage in form of direct transfer using short-range radio, such as Bluetooth®, or an infrared connection, or a cable.

The connection may also include an external storage 8, such as a memory card connectable to the devices, one device at time. The external storage 8 may also involve a computer, in which case the first and second mobile stations may be both connected to the computer through i.e. a universal serial bus, USB.

A key security feature in the transfer procedure is that the encrypted key file is encrypted with a key, typically issued indirectly by the rights issuer or directly by the receiving device. The indirect transfer and direct transfer will have two different initialization steps in the transfer procedure.

In the indirect transfer initialization, the encrypted key file 5 is encrypted with a rights issuer key as the secondary key 6, retrieved from a previous secure rights object download. This means that the rights issuer public key is stored/cached when rights objects are downloaded.

In the direct transfer, the key file 5 is encrypted with a public key of the receiving second mobile station MS2 as the secondary key 6. To get access to the public key of the second mobile station, the storage medium must first have been accessed by the second mobile station, which stores its public key on the medium. In the case of OMA DRM 2.0, this would typically be stored in the form of a RORequest message.

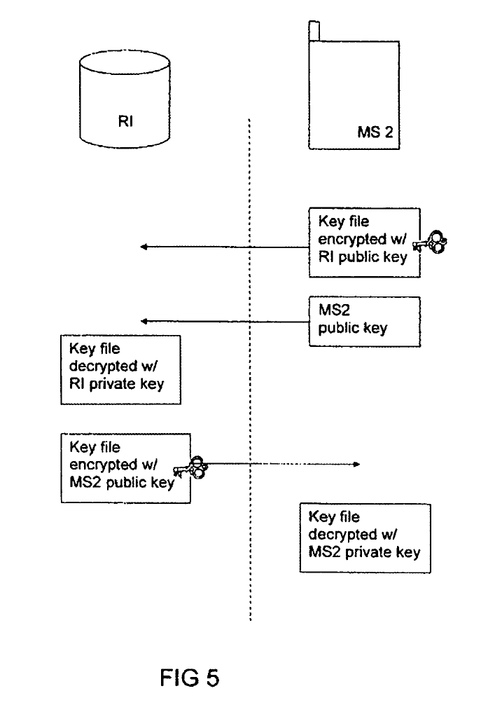

A typical direct transfer procedure is described below and shown schematically in FIG. 4.

Since the content item 1 is encrypted with the rights object, the transfer of the content item is not sensitive. Thus, the transfer of the content item is straightforward and is not shown in the flow diagram. The steps need not necessarily be performed in the listed order, as they are performed by different entities. The order in which the content item, the encrypted rights object file, and the encrypted key file are received does not matter.

In one embodiment, the following steps are performed:

MS2 saves its public key on the storage medium.

MS1 gets the MS2 public key and encrypts the key file 5 by means of the MS2 public key as the secondary key 6.

MS1 saves the encrypted key file 5 (KeyFileForEncryptedROFile) on the storage medium.

The encrypted key file is deleted from MS1. Now MS1 is unable to use the encrypted ROFile.

MS1 saves the encrypted ROFile 3 on the storage medium.

MS2 fetches the encrypted key file 5 from the storage medium.

MS2 regenerates the key file 5, i.e. the key file 5 is decrypted and re-encrypted using a MS2 specific key, e.g. the MS2 private key.

MS2 fetches the encrypted rights object file from the storage medium.

MS2 deletes the encrypted rights object file 3 from the storage medium.

MS2 is now able to access the information in the encrypted rights object file 3 by means of the key contained in the regenerated key file 5, now residing in the second mobile station MS2.

The indirect transfer procedure is similar to the one described above. In the indirect transfer, an external storage medium is connected to the first mobile station MS1 that stores all files to be transferred on it. The external storage medium is then disconnected from the first mobile station MS1 and connected to the second mobile station MS2, which can interact with the files in the storage medium. In the indirect transfer, the first mobile station 1 uses a public key of the rights issuer as the secondary key 6 to encrypt the key file 5. Preferably, the first mobile station inserts the URL address of the rights issuer server in the key file indicating to the second mobile station what server to access. Later the second mobile station MS2 will be able to perform a secure key download from the rights issuer server.

The exchange of keys and decryption/encryption of the key file are described with reference to FIG. 5. Actions at the right issuer are to the left and actions at the second mobile station MS2 are to the right. The second mobile station MS2 has received the key file encrypted with the public key of the rights issuer RI (encrypted and sent by the first mobile station MS1). The second mobile station MS2 sends this key file together with its own public key, MS2 public key, to the rights issuer RI. The rights issuer RI decrypts the key file with its own private key, and re-encrypts the key file with the public key of the second mobile station MS2. The rights issuer RI sends this re-encrypted key file to the second mobile station MS2 who in turn decrypts the key file with its own private key, MS2 private key.

The transfer procedures are also applicable if each rights object is stored in a single file, or in a database record. The indirect transfer procedure is possible even if rights objects are issued by several separate rights issuer servers.

The rights object syntax can be extended with a rule describing the backup method allowed by the rights issuer, i.e. backup=indirect or backup=direct. This gives the rights issuer full control of which backup mechanism that should be used. For example, the rights issuer may prohibit a direct transfer which does not involve a download of rights object from the rights issuer server.

The invention makes it possible for a user to backup and restore rights objects and transfer rights objects in a safe fashion to other devices. The invention also makes it possible for a content provider or rights issuer to control if backup and transfer should be allowed or not, and in which manner.

The invention may be implemented by means of hardware and software as will be appreciated by a person skilled in the art. The scope of the invention is only limited by the claims below.

What is claimed is:

1. A method for transfer of a content item and associated rights object from a first device to a second device, the content item being encrypted with the rights object, both the content item and the rights object initially being stored in the first device, comprising the steps of:
in the first device, forming an encrypted rights object file containing at least one rights object and being encrypted with a key file decryption key;
forming an encrypted key file containing said key file decryption key encrypted with a secondary key;
transferring from the first device to the second device: the content item, the encrypted rights object file, and the encrypted key file;
and in the second device:
receiving the content item, the encrypted rights object file, and the encrypted key file;
regenerating the key file decryption key from the encrypted key file by decryption with the secondary key;
decrypting the rights object file with the key file decryption key; and
decrypting the content item file with the associated rights object.

2. A method according to claim 1, comprising the further steps of deleting the encrypted key file from the first device after transfer thereof.

3. A method according to claim 2, comprising the further steps of deleting the encrypted rights object file from the first device after transfer thereof.

4. A method according to claim 1, wherein a connection between the first device and the second device is established.

5. A method according to claim 4, wherein the secondary key is a device specific key of the second device, exchanged over the connection and used by the first device to encrypt the key file.

6. A method according to claim 5, wherein the connection is established over a storage medium, the storage medium temporarily storing the files to be transferred.

7. A method according to claim 6, comprising the further steps of deleting the encrypted key file from the storage medium after the second device has received the encrypted key file.

8. A method according to claim 5, wherein the connection is established over an infrared link.

9. A method according to claim 5, wherein the connection is established over a radio link.

10. A method according to claim 1, wherein the secondary key is a public key of the rights issuer who issued the rights object, the method comprising the further steps, in the first device, of downloading said public key of the rights issuer, inserting the URL address of the rights issuer in the key file and using said public key to encrypt the key file, and in the second device, after receiving the encrypted rights object file and encrypted key file, establishing a connection to the rights issuer, sending the key file together with its own public key to the rights issuer RI, the rights issuer RI decrypting the key file with its own private key, and encrypting the key file with the public key of the second device MS2, the rights issuer RI sending this newly encrypted key file to the second device who in turn decrypts the key file with its own private key.

11. A method according to claim 10, wherein the rights object is defined to allow transfer using a public key of the rights issuer who issued the rights object exclusively.

12. A method according to claim 10, wherein the file transfer is performed by means of an external memory.

13. A method according to claim 11, wherein the file transfer is performed by means of an external memory.

14. A device comprising: a storage means for storing files, processor means capable of performing encryption and decryption operations, and of executing a content item, wherein the device is adapted to transfer a content item and associated rights object to another device by:
forming an encrypted rights object file containing at least one rights object and being encrypted with a key file decryption key;
forming an encrypted key file containing said key file decryption key encrypted with a secondary key;
transferring the content item, the encrypted rights object file, and the encrypted key file to said other device; and wherein the device is adapted to receive a content item and associated rights object from another device by:
receiving the content item, the encrypted rights object file, and the encrypted key file;
regenerating the key file decryption key from the encrypted key file by decryption with the secondary key;
decrypting the rights object file with the key file decryption key; and
decrypting the content item file with the associated rights object.

15. A device according to claim 14, wherein the device is adapted to delete the encrypted key file after transfer thereof.

16. A device according to claim 15, wherein the device is adapted to delete the encrypted rights object file after transfer thereof.

17. A device according to claim 14, wherein the device is adapted to establish a connection to the other device.

18. A device according to claim 17, wherein the device is adapted to receive a device specific key of the other device over the connection and to use it as the secondary key to encrypt the key file.

19. A device according to claim 18, wherein the device is adapted to establish the connection over a storage medium, and to store the files to be transferred temporarily on the storage medium.

20. A device according to claim 19, wherein the device (during reception) is adapted to delete the encrypted key file from the storage medium after the device has regenerated the key file decryption key.

21. A device according to claim 17, wherein the device is adapted to establish the connection over an infrared link.

22. A device according to claim 17, wherein the device is adapted to establish the connection over a radio link.

23. A device according to claim 14, wherein, for transfer, the device is adapted to download a public key of the rights issuer who issued the rights object, insert the URL address of the rights issuer in the key file and use said public key to encrypt the key file, and for reception, after receiving the encrypted rights object file and encrypted key file, the device is adapted to establish a connection to the rights issuer, to send the key file together with its own public key to the rights issuer RI, to receive the key file decrypted with the private key of the rights issuer, and re-encrypted with the public key of the device, and to decrypt the key file with its own private key.

24. A device according to claim 23, wherein the device further comprises a connector for connecting an external memory, and is adapted to perform the file transfer by means of such an external memory.

25. A device according to claim 14, wherein the device is a portable telephone, a pager, a communicator, a smart phone, an electronic organiser, a computer, a personal digital assistant, or an mp3 player.
